(19) United States
(12) Patent Application Publication
(10) Pub. No.: US 2026/0225967 A1
(43) Pub. Date: Aug. 6, 2026

(54) METHOD FOR RECOVERING VALUABLE CONSTITUENTS FROM STRUVITE

(71) Applicant: BIOTA HOLDING B.V., TT ROELOFARENDSVEEN (NL)

(72) Inventor: Petrus Franciscus KLEIN, TT ROELOFARENDSVEEN (NL)

(21) Appl. No.: 19/150,904

(22) PCT Filed: Jan. 26, 2024
(86) PCT No.: PCT/NL2024/050036

§ 371 Date: Jul. 24, 2025

(30) Foreign Application Priority Data
Jan. 27, 2023 (NL) 2034034

(51) Int. Cl. C05B 17/02; C01B 25/234; C01C 1/02; C05C 3/00

(52) U.S. Cl. CPC C05B 17/02; C01B 25/2346; C01C 1/024; C05C 3/00

(57) ABSTRACT

The present invention relates to a method for recovering valuable constituents from struvite, and also to a method for organically cultivating plants on a substrate in which one or more residual streams comprising the recovered constituents are used. An object of the present invention is therefore that of providing a method for recovering valuable constituents from struvite, which constituents can subsequently be used in organic agriculture and horticulture.

The present invention relates to a method for recovering valuable constituents from struvite, and also to a method for organically cultivating crops, including plants, on a substrate in which one or more residual streams comprising the recovered constituents are used.

Struvite, or magnesium ammonium phosphate, is a mineral having the composition Mg(NH₄)PO₄·(H₂O). Struvite is obtained, for example, during the purification of wastewater. In a water treatment plant in Amsterdam Westpoort, there is an installation for recovering phosphate from sewage water, which is thereafter used to make struvite. After the sewage water has been cleaned, there remains at the end a sludge from which struvite is obtained by adding a number of specific compounds, including magnesium compounds, such as for example magnesium chloride, magnesium oxide, magnesium hydroxide. It has also been found to be possible to obtain struvite from urine that is, for example, collected from large events and concerts, but also from certain waste streams originating from the processing industry and water treatment plants. Such waste streams can be both of plant and animal origin.

The recovery of struvite is known per se from the prior art.

US patent application US 2005/023220 discloses a method for removing phosphorus from phosphorus-containing sewage water including filtrate and biological solids, comprising the steps of bringing the sewage water into contact with a first polymeric membrane reactor and removing phosphorus as primary struvite, adding Mg in order to make the sewage water supersaturated with struvite and bringing the wastewater into contact with a second monomolecular membrane and removing phosphorus as secondary struvite.

US patent application US 2016/185633 discloses a method for efficiently removing phosphorus and nitrogen nutrients from wastewater via struvite precipitation, comprising providing a sequential batch reactor, introducing wastewater into the reactor, seeding the sequential batch reactor with biomass, adjusting the pH in the reactor, aerating the contents of the reactor, and allowing the sludge to settle, wherein the step of removing the sludge is effected after stopping the aeration. The sludge thus removed is suitable for use as soil improver.

U.S. Pat. No. 7,622,047 discloses a method for obtaining one or both of phosphorus and nitrogen from wastewater, comprising: introducing the wastewater into a column comprising a harvesting section and at least two vertically sequential sections above the harvesting section, maintaining supersaturation conditions for struvite, a struvite analogue, or a phosphate compound in the harvesting section, recycling wastewater which has passed through the column while maintaining a supersaturation ratio of struvite, a struvite analogue, or a phosphate compound in the harvesting section to produce pellets of struvite, struvite analogue, or phosphate compound, and extracting from the harvesting section the pellets formed within the column, which pellets comprise struvite, a struvite analogue or a phosphate compound.

US patent application US 2022/0315460 relates to a method for decomposing struvite, consisting of the following steps: dissolving a composition that comprises struvite in a mineral acid, resulting in the formation of a solution having an acidic pH, removing magnesium from the solution by increasing the pH of the solution to a pH in the range from 4.5 to 6, precipitating magnesium compounds that do not contain any ammonium, and separating magnesium compounds from said solution, to obtain a solution of the ammonium salt of the mineral acid. Examples of mineral acids mentioned are by-products obtained from industrial processes, namely sulfuric acid, hydrochloric acid, nitric acid, and phosphoric acid.

International application WO 2020/242366 relates to a method for decomposing struvite, consisting of the following steps of dissolving a starting material comprising struvite in sulfuric acid, thus forming a solution, removing phosphate ions, and precipitating magnesium compounds therefrom and increasing the pH, thus forming a solution comprising ammonium sulphate.

Struvite is thus a phosphate-rich mineral that is recovered from waste materials, for example sewage water, urine or blanching water that is released in the processing of potatoes. Struvite is suitable as a phosphate fertilizer. Regional water authorities, owners of sewage water treatment plants and potato processors have all in recent years striven to interest farmers in the use of struvite in the fertilizing of crops. Because struvite is made from recovered phosphate, the authorities do not consider the fertilizer to be synthetic fertilizer. Struvite is in theory highly suitable for grass cultivation because of the slow release of active substances and the use of struvite in agriculture fits seamlessly into the circular concept.

Agriculture can be understood to be a “managed ecosystem” that is optimized for the production of food or fodder crops, and this also applies to the soil as a basis thereof. In organic agriculture, supplementary fertilization with P, K, S, Mg and Ca in the form of crude minerals is permitted in order to make up any deficiencies in the cycle present. Adequate availability of the necessary food substances or nutrients is an ongoing point of concern and often also a challenge for organic farmers. This concerns then both macronutrients (N, P, K, S, Mg, Ca) and micronutrients (trace elements) B, CI, Cu, Fe, Mn, Mo, Zn and Si.

In 2022, the area for organic agriculture in the Netherlands grew to 79 853 hectares (excluding land in transition), bringing the proportion of area for organic agriculture to 4.4%. The number of organic agriculture businesses has also risen, from 2208 to 2242. With a stagnating market and the organic area of 4.4%, the Netherlands is trailing far behind the European average of 9.2%. The “Groei van biologische productie en consumptie [Growth of organic production and consumption]” action plan from the Dutch Ministry of Agriculture, Nature and Food Quality sets a target of 15% organic agriculture area by 2030.

On the international level, regulations are set out which all organic enterprises in the EU must adhere to in order to be able to be qualified as “organic”. These regulations ensure that everyone working in organic food production is working to the same values, in particular the international EU values of “health, ecology, fairness and care”.

It is thus desirable that in organic agriculture and horticulture fertilizers are used that are of biological origin.

An object of the present invention is therefore that of providing a method for recovering valuable constituents from struvite, which constituents can subsequently be used in organic agriculture and horticulture.

The present invention thus relates to a method for recovering valuable constituents from struvite, the method comprising the following steps:
a) providing struvite,
b) bringing struvite into contact with one or more acidic compounds in order to form a mixture,
c) further processing the mixture obtained after step b) in order to obtain one or more residual streams rich in magnesium, ammonium and/or phosphoric acid.
   A particular embodiment is also possible in which other phosphorus-based acids are obtained, for example phosphorous acid.

The use of such a method achieves the objective underlying the invention.

According to one example of the present method, the one or more acidic compounds used in step b) are chosen from the group of citric acid, formic acid, malic acid, acetic acid, lactic acid, gluconic acid and ascorbic acid, or a combination thereof. Such acids can be of biological origin, as a result of which they are exceptionally suitable for use in the present method. For example, acetic acid can be obtained in the fermentation of alcohol using Acetobacter aceti.The aforementioned acids are in particular organic acids, namely compounds comprising carbon and at least one carboxyl group (—COOH).

The biological production of the aforementioned organic acids is performed by microorganisms such as bacteria, fungi, or yeasts. In one embodiment, citric acid is obtained using Aspergillus niger (fungus), with fermentation of sugars (for example glucose or sucrose) by Aspergillus niger taking place. In one embodiment, formic acid is obtained using certain bacteria, such as Acetobacterium woodii, in particular in the anaerobic fermentation of carbohydrates. In one embodiment, malic acid is obtained using Aspergillus niger or certain bacteria, such as Bacillus subtilis, in particular in the fermentation of sugars. In one embodiment, lactic acid is obtained using Lactobacillus acidophilus, in particular in the fermentation of sugars, usually lactose in milk. In one embodiment, gluconic acid is obtained using glucose oxidase-producing bacteria, such as Aspergillus niger. In one embodiment, ascorbic acid is obtained using yeasts, such as Saccharomyces cerevisiae, in particular via biosynthesis from sugars, often via a number of enzymatic steps.

It is especially desirable in the present invention to use acidic compounds because they can readily form complex compounds with phosphate. As a result of the formation of such complex compounds with phosphate, in the later use, in particular the provision of a food composition for plants and crops, the dissolution of the phosphate is of great importance in order thus to be available for the plants and crops to be grown.

Such aqueous food compositions are used in particular for the growing of plants and crops on a substrate, namely hydroculture comprising substrates such as rock wool, perlite, clay granules and coconut fibre. In hydroculture, plants and crops are grown without earth, with nutrients being added directly to the water as food composition.

In one embodiment, it is also possible to use a mineral acid, namely nitric acid, as long as it is obtained via a biological route. One possible way to produce nitric acid comprises the use of bacteria that can convert ammonia into nitric acid via a process known as nitrification. Bacteria such as Nitrosomonas and Nitrobacter are examples of microorganisms that are involved in this process. Sulfuric acid is considered unsuitable because sulfuric acid cannot be obtained simply via a biological route.

According to one example of the present method, the amount of struvite in the mixture according to step b) is at most 95% by weight, preferably at most 50% by weight, particularly preferably at most 30% by weight.

According to one example of the present method, the further processing according to step c) comprises one or more steps chosen from the group of crystallization, filtration, ion exchange, bipolar electrodialysis and decantation.

According to one example of the present method, the further processing according to step c) comprises separating a residual stream rich in magnesium and a residual stream rich in ammonium and phosphate off from the mixture according to step b), with in particular the residual stream rich in ammonium and phosphate being further processed to give a residual stream rich in ammonium and a residual stream rich in phosphate.

The present invention further concerns the residual streams obtained with the method, in particular a residual stream rich in ammonium, a residual stream rich in magnesium and/or a residual stream rich in phosphate.

The residual streams obtained with the present method are particularly suitable for the organic cultivation of crops, including plants, in or on a substrate. The growing of crops, including plants, on a substrate is a cultivating method known per se. Examples of such substrates are potting soil, coconut, wood fibres, reed clippings, glass wool and rock wool, but foam types of polyphenols and polyurethane compounds can also be used for the so-called hydroculture.

The present invention also concerns a method for organically cultivating crops, including plants, on a substrate, comprising the addition of one or more residual streams obtained as described above to the substrate.

The residual streams obtained with the present method are particularly suitable for the preparation of an organic plant food, the organic plant food being suitable for the organic cultivation of plants in a substrate.

The present invention also concerns the use of an organic liquid for the organic cultivation of plants in a substrate, in which organic liquid one or more residual streams obtained with the present method are incorporated.

The present invention further concerns a method for organically cultivating plants on a substrate, comprising the addition of an organic liquid comprising one or more residual streams, obtained according to the present invention, to the substrate.

The present invention shall be elucidated hereinafter on the basis of an example.

A quantity of struvite is first ground to a fine powder, for example with a grinding unit suitable for this purpose, for example a ball mill, but the invention is not limited thereto. The thus obtained fine struvite is then dissolved in an organic acid, in particular an organic acid that is permitted pursuant to the organic regulations or for example an organic acid produced by a biological route. One example of this is citric acid.

After the thus obtained fine struvite has been brought into contact with citric acid, it is desirable to stir the resulting mixture in order to promote the dissolution of struvite. This dissolution can for example take up to two weeks, during which the liquid is kept in constant motion. As a result of the release of the minerals, the viscosity of the liquid will increase. In one particular embodiment, it is possible to set the amount by weight of struvite to a value of for example 95% by weight. It is also possible to set the amount by weight of struvite to a lower value, for example 25% by weight. In the thus obtained mixture there is salt formation, for example the formation of one or more of magnesium citrate and ammonium citrate, and a phosphorus-based acid, in particular phosphoric acid.

The thus obtained mixture is usable as a fluid fertilizer, optionally for later dilution, if desirable. However, it is also possible to use one or more subsequent steps in order thus to recover therefrom a magnesium-rich stream, in particular through one or more workup steps, preferably in the order of crystallization, filtration, ion exchange, bipolar electrodialysis and decantation. It is also possible to obtain an ammonium-rich stream and a phosphate-rich stream, for example by bipolar electrodialysis or by ion exchange, wherein ammonium is captured by another counterion which is legally permitted in organic agriculture and horticulture.

1. Method for recovering valuable constituents from struvite, the method comprising the following steps:
a) providing struvite,
b) bringing struvite into contact with one or more acidic compounds in order to form a mixture,
c) further processing the mixture obtained after step b) in order to obtain one or more residual streams rich in magnesium, ammonium and/or phosphoric acid.

2. Method according to claim 1, characterized in that the one or more acidic compounds used in step b) are chosen from the group of citric acid, formic acid, malic acid, acetic acid, lactic acid, gluconic acid and ascorbic acid, or a combination thereof; in particular the aforementioned one or more acidic compounds are derived from a biological source.

3. Method according to claim 1, characterized in that the amount of struvite in the mixture according to step b) is at most 95% by weight, preferably at most 50% by weight, particularly preferably at most 30% by weight.

4. Method according to claim 1, characterized in that the further processing according to step c) comprises one or more steps chosen from the group of crystallization, filtration, ion exchange, bipolar electrodialysis and decantation.

5. Method according to claim 1, characterized in that the further processing according to step c) comprises separating a residual stream rich in magnesium and a residual stream rich in ammonium and phosphate off from the mixture according to step b).

6. Method according to claim 5, characterized in that the residual stream rich in ammonium and phosphate is further processed to give a residual stream rich in ammonium and a residual stream rich in phosphate.

7. Residual stream rich in ammonium, obtained by a method according to claim 1.

8. Residual stream rich in magnesium, obtained by a method according to claim 1.

9. Residual stream rich in phosphate, obtained by a method according claim 1.

10. Food composition for the organic cultivation of plants in a substrate comprising one or more residual streams according to one or more of claim 7.

11. Use of one or more residual streams obtained by a method according to claim 1 for the organic cultivation of plants in a substrate.

12. Method for organically cultivating plants on a substrate, comprising the addition of one or more residual streams obtained by a method according to claim 1 to the substrate.
